(19) United States
(12) Patent Application Publication
(10) Pub. No.: US 2026/0027865 A1
(43) Pub. Date: Jan. 29, 2026

(54) METHODS AND DEVICES FOR THERMAL MANAGEMENT OF ELECTRIC VEHICLES AND THEIR CABINS IN COLD ENVIRONMENTS

(71) Applicant: Omnitek Partners LLC, Ronkonkoma, NY (US)

(72) Inventor: Jahangir S. Rastegar, Stony Brook, NY (US)

(73) Assignee: Omnitek Partners LLC, Ronkonkoma, NY (US)

(21) Appl. No.: 19/280,699

(22) Filed: Jul. 25, 2025

Related U.S. Application Data
(60) Provisional application No. 63/676,668, filed on Jul. 29, 2024.

(51) Int. Cl. B60H 1/00

(52) U.S. Cl. CPC B60H 1/00392; B60H 1/00278; B60H 1/00807; B60H 1/00864; B60H 1/00878

(57) ABSTRACT

A system for thermal management of electric vehicles. The system including: a heat energy storage system having a phase change material; and a controller comprising hardware. The controller being configured to: monitor a cabin temperature of a cabin of the electric vehicle; based on the cabin temperature, control power to the heat energy storage system to store heat energy therein; and control an airflow at least indirectly across the phase change material to convert the stored heat energy to heating the cabin.

### CROSS REFERENCE TO RELATED APPLICATION

This application claims the benefit of U.S. Provisional Application No. 63/676,668, filed on Jul. 29, 2024, the entire contents of which is incorporated herein by its reference.

### BACKGROUND

### Field

This disclosure is directed to methods and devices for keeping cabins of electric powered vehicles in cold environments using Phase Change Material (PCM) based heat energy storage devices that are heated primarily by external electrical power sources while the electrically powered vehicles is not being used.

### Prior Art

Electric powered vehicles are becoming more popular and widespread. Cars are not the only type of vehicles that can be an electric powered vehicle. For example, buses, trucks, lift-trucks, boats, locomotives, airplanes and heavy-duty vehicles are also available as electric powered vehicles.

Electric vehicles are usually powered by an electrical energy storage system. The energy storage system here being defined as any kind of battery, battery pack or series of batteries for powering the electric vehicle.

It is appreciated that for practical reasons, it is important that the electrical energy storage system has a long lifetime, i.e., a large number of charge/discharge cycles as possible before the cells fail to operate satisfactorily. Keeping the electrical energy storage system in an optimal temperature range is essential to maximizing its lifetime.

The present disclosure can be particularly useful for keeping the cabin temperature of an electric vehicle at a comfortable temperature for electric powered vehicles that carry out work within relatively small areas, and are not used for long distance travel, like school and other similar busses, or even city busses that stop at each end of their route, during which they have line power available. Other similar applications are for mobile machinery type, such as bulldozers, dump trucks, excavators, agricultural and farming machinery, and the like, which is carrying work within a small area and is not used for long distance travel. Any of such vehicles are considered “electric vehicles” within the meaning used in this disclosure. In all such above electric powered vehicles, the vehicles are typically parked outdoors when they are not in use and can be exposed to low and sometimes extremely low temperatures.

The performance of batteries and super-capacitors is significantly reduced at low temperatures. This is the case for both primary and rechargeable batteries. In addition, current lithium-ion and Lithium-polymer battery technology does not allow battery charging at temperatures below zero degrees C. and charging at temperatures below their optimal level has been shown to irreversibly damage the battery and consequently reduce battery life.

Electrical energy storage systems which are cold would take a lot of energy and time to heat to the working temperature above the minimum optimal operating range of their batteries. Therefore, it is essential to preheat these electrical energy storage systems using external power sources to ensure that the maximum amount of electrical energy is available for the electrically powered vehicle operation.

In current electrically powered vehicles, the power for heating the passenger compartment in cold environments comes from electrical energy storage system. Therefore, it is highly desirable to use other sources of energy for this purpose so that the stored electrical energy can be used for operating the electric powered vehicle. Such methods and devices can be suitable for the aforementioned electric powered vehicles and machinery such as school buses, municipal busses, bulldozers, dump trucks, excavators, airport vehicles, agricultural and farming machinery, and the like, which perform their work within a relatively small area and for during limited lengths of time.

For example, a school bus may start its round from its parking location in the morning around 7:00 Am and pick up students and drop them at their schools once or twice and drive back to its parking location by 9:30 to 10:00 Am, i.e., for a total of 2-3 hours. The bus would then have access to external power sources, usually a line power, to charge the vehicle batteries and power other provided onboard devices. It is appreciated that such an electric powered bus would typically be parked outdoors when they are not in use and can be exposed to low and sometimes extremely low temperatures.

Current solutions that try to address cold weather effects on electric power systems, i.e., batteries, include heating the exterior of the battery by integrating “heaters” into the battery compartment or using heating blankets, or recently by embedding heating elements inside the batteries.

A newly developed method and related devices has the advantage of rapidly and efficiently heating the battery electrolyte directly using appropriately formed high frequency AC currents. The methods and devices take advantage of the electrical characteristics of the batteries and super-capacitors to heat the electrolyte directly and very rapidly to its optimal operating temperature without causing any damage as described in the following U.S. Pat. Nos. 10,063,076; 10,855,085; 11,211,809; 11,211,810; 11,594,908; 12,074,301, as well as U.S. Patent Application Publication Nos. 2020/0176835; 2021/0304972; 2021/0307113; 2022/0113750; 2023/0344029; 2024/0136616; 2023/0359231 and U.S. patent application Ser. No. 18/244,275, the entire contents of each of which are incorporated herein by reference.

The high frequency AC current electrolyte heating units may be externally powered, even at very low battery temperatures. However, once the battery is warm enough to provide enough power, the battery temperature may be raised to its optimal level and maintained at that level by power from the battery itself. The battery may be fully charged or discharged as it is heated.

The high frequency AC current electrolyte heating units are inherently highly efficient and safe and can be readily integrated into the battery safety and protection circuitry and battery chargers.

The following are some of the main characteristics of the high frequency AC current electrolyte heating methods and devices:
It requires no modification to the battery.
The basic physics of the process and extensive tests clearly show no damage to the battery and super-capacitor.
The battery pack protection electronic units, such as those for Lithium-ion and Lithium-polymer batteries, can be modified to ensure continuous high-performance operation at low temperatures.
The battery electrolyte is directly and uniformly heated, therefore bringing a very cold battery to its optimal operating temperature very rapidly and minimizing heat loss from the battery.
Direct electrolyte heating requires significantly less electrical energy than external heating such as with the use of heating blankets.
Standard sized Li-ion or Li-polymer batteries can be used instead of thin and flat battery stack packaging to accelerate external heating via heating blankets or the like.
The technology is simple to implement and low-cost.

The disclosed methods and devices for keeping an electric vehicle's cabin (herein, the terms cabin and passenger compartment are used interchangeably) warm, i.e., at a comfortable temperature for its occupants, can be suitable for electric powered vehicles and machinery such as school buses, municipal buses, bulldozers, dump trucks, excavators, airport vehicles, agricultural and farming machinery, and the like, which perform their work within a relatively small area and for limited lengths of time. In addition, systems developed using the disclosed methods and devices can also use the above high frequency AC current battery electrolyte and super-capacitor (where used) components of the electric powered system before charging the batteries as well as before the electric powered vehicle is to be operated.

### SUMMARY

Methods and devices for electric powered vehicles to keep their cabin temperature at a comfortable level for their occupants in cold environments are disclosed. The disclosed methods and devices can be suitable for electric powered vehicles, such as school buses and the like, which perform their work within a relatively small area and for relatively limited lengths of time.

Electric powered vehicles such as buses are generally parked in open parking areas in cold environments, where they are also charged and have access to line power. It is therefore highly desirable to use the available line power to provide the means of eliminating or at least minimizing the need to use power from the stored electrical energy of the electric powered vehicle to keep the occupants of the vehicle at a comfortable temperature.

There is therefore a need for methods and devices that can be powered by line power to bring electric powered vehicles cabin interior space to a comfortable temperature in cold environments for its passengers and keep the cabin interior space at a comfortable temperature while the vehicle is in operation.

It is also highly desirable that in cold environments, the electric powered vehicle cabin interior space be at a comfortable temperature at the time it starts its operation but utilizes no or minimal energy while it is parked and out of service, such as overnight.

There is therefore also a need for methods and devices that can be powered by line power to bring the interior cabin space of electric powered vehicles to a comfortable temperature for its passengers in cold environments as the vehicle begins its operation. Accordingly, methods and systems are provided that can be used in electric powered vehicles, such as in electric powered vehicles or fleet vehicles, that utilize line power to bring electric powered vehicles cabin interior space to a comfortable temperature in cold environments for its passengers and keep the cabin interior space at a comfortable temperature while the vehicle is in operation.

It is appreciated that electrical energy storage systems which are very cold would take a lot of electrical energy to heat to their optimal working temperature. Therefore, it is especially useful to preheat these electrical energy storage systems using external line power or the like.

Therefore, the systems, methods and devices can also use the aforementioned high frequency AC current battery electrolyte and super-capacitor (where used) heating systems to bring the electrical energy storage units (batteries) of the electric powered vehicles to its optimal operating temperature before the electric powered vehicle begin its operation; before or during the electrical energy storage units (batteries) are charged; and keep the electrical energy storage units (batteries) at their optimal operating temperature while the vehicle is being operated.

There is therefore a need for methods and systems that can be powered by line power to bring electric powered vehicles cabin interior space to a comfortable temperature in cold environments for its passengers and keep the cabin interior space at a comfortable temperature while the vehicle is in operation as well as use the aforementioned high frequency AC current battery electrolyte and super-capacitor (where used) heating systems to bring the electrical energy storage units (batteries) of the electric powered vehicles to its optimal operating temperature before the electric powered vehicle begin its operation; before the electrical energy storage units (batteries) are charged; and keep the electrical energy storage units (batteries) at their optimal operating temperature while the vehicle is being operated.

Accordingly, methods and systems are provided that are powered by line power to bring electric powered vehicles cabin interior space to a comfortable temperature in cold environments for its passengers and keep the cabin interior space at a comfortable temperature while the vehicle is in operation as well as use the aforementioned high frequency AC current battery electrolyte and super-capacitor (where used) heating systems to bring the electrical energy storage units (batteries) of the electric powered vehicles to its optimal operating temperature before the electric powered vehicle begin its operation; before the electrical energy storage units (batteries) are charged; and keep the electrical energy storage units (batteries) at their optimal operating temperature while the vehicle is being operated.

### BRIEF DESCRIPTION OF THE DRAWINGS

FIG. 1 illustrates a block diagram of a line (external power source) powered system to raise the cabin temperature of an electric powered vehicle to a comfortable temperature for its occupants and keep it at a comfortable temperature while the vehicle is in operation.

FIG. 2 illustrates a cross-sectional view of a typical “Phase-Change-Material (PCM) Heat Energy Storage Unit” configuration.

FIG. 3 illustrates a cross-sectional view of an electrically heated PMC assembly cartridge of the “Phase-Change-Material (PCM) Heat Energy Storage Unit” of FIG. 2.

### DETAILED DESCRIPTION

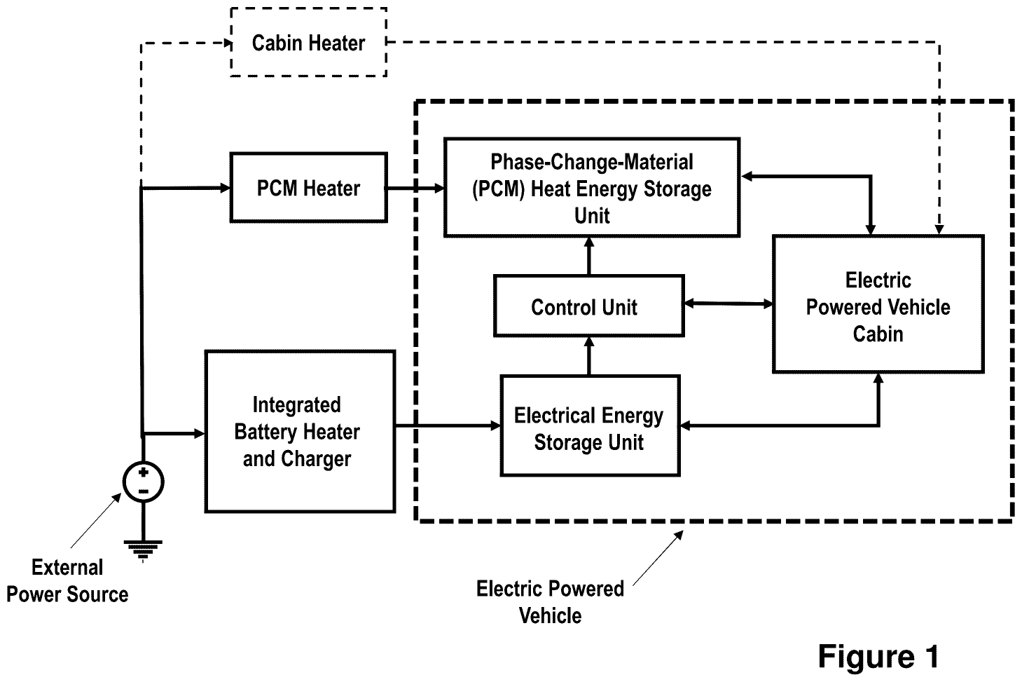

A method that uses line power (hereinafter, line power includes all external electrical power sources such as commercially provided power lines, generators of various type, energy harvesting devices such as those using solar cell or wind or wave powered generators, and the like are intended to be indicated) to bring electric powered vehicles cabin interior space to a comfortable temperature in cold environments for its passengers (occupants) prior to use by a passenger(s) and further to keep the cabin interior space at a comfortable temperature while the vehicle is in operation is shown in the block diagram of FIG. 1.

FIG. 1 illustrates the block diagram of a line powered system to raise the cabin temperature of an electric powered vehicle to a comfortable temperature for its occupants and keep it at a comfortable temperature while the vehicle is in operation. In the block diagram of FIG. 1, the “Electrical Energy Storage Unit”, can comprise battery packs and can also include their safety and power management electronics; the “Phase-Change-Material (PCM) Heat Energy Storage Unit”; the “Electric Powered Vehicle Cabin”, i.e., where the vehicle operator/occupants/passengers are housed; and the vehicle cabin temperature “Control Unit” are the only components of the electric powered vehicle that are shown inside a dashed line rectangle. In the block diagram of FIG. 1, the electric powered vehicle is considered to be parked at its charging station, and is shown to be connected to an “Integrated Battery Heater and Charger” as well as a “PCM Heater”, both of which are powered by an “External Power Source”, i.e., usually line power. A conventional charger can also be used in the place of the integrated battery heater and charger. Each component of the block diagram of FIG. 1 and their operation as well as the design operation of the entire system are described below.

Phase change materials (PCMs) are materials that absorb and release large amounts of energy when they change phases, for example from solid to liquid or liquid to gas, to provide the stored energy for heating or cooling a system. In most cases, the change of matter happens between solid to liquid.

The material melts or solidifies at the phase change temperature (PCT), and by doing so a PCM is capable of absorbing or releasing a substantial amount of energy as compared to normal. Energy is stored or released by changes of state or by a change in the internal structure—this is why PCMs are also called latent heat storage (LHS) materials. Types of phase change materials include, organic PCMs, inorganic PCMs, and eutectic PCMs. Organic phase change materials (PCM) are most commonly made of hydrocarbon-based substances, such as paraffin compounds or fatty acids. Inorganic PCMs are commonly fabricated from salt hydrates or metals. They are distinctly efficient in terms of energy storage and have better thermal conductivity as compared to organic PCMs. Eutectic PCMs combine two or more organic or inorganic PCMs and include Organic-organic PCM, Organic-Inorganic PCM and Inorganic-inorganic PCM.

Latent heat is the energy absorbed or released by materials during phase transition. A phase-change material (hereinafter referred to as the PCM) is a latent heat storage material characterized by a large heat of fusion. The PCM effectuates heat storage by absorbing and releasing heat at constant temperature during phase transition, such as phase change from solid state to liquid state to gas state, or reversibly. At a phase-transition temperature, the PCM absorbs heat when melting, and releases heat when solidifying, without significant change of temperature. Therefore, the PCM is capable of storing and releasing a large amount of thermal energy.

It is appreciated that latent heat storage materials have much higher latent heat storage density than sensible heat storage materials and thus are more advantageous than sensible heat storage materials in terms of heat storage level and volume. For example, phase-changing materials made from zinc or tin with melting temperatures of 420° C. and 230° C., respectively, have latent heat of melting of 112 kJ/Kg and 59 112 KJ/Kg, respectively.

It is appreciated that since the PCM is to be heated to its melting temperature, it has to be housed in “containers” with proper housing to withstand the high melting temperatures of the PCM. In addition, the “Phase-Change-Material (PCM) Heat Energy Storage Unit” must be configured to also perform as a heat exchanger to allow transfer of heat energy into the electric powered vehicle cabin via mostly circulating air flow.

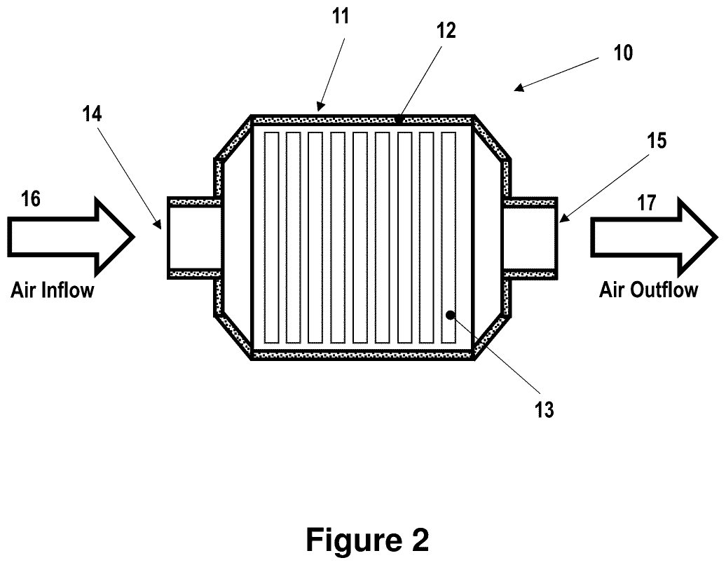

The cross-sectional view of a typical “Phase-Change-Material (PCM) Heat Energy Storage Unit” design, hereinafter also referred to as “PCM Unit”, is shown in FIG. 2 and is indicated by the numeral 10. The “PCM Unit” is provided with a housing 11, which is provided with a layer 12 of thermal insulation to minimize heat loss from the heat energy storage unit. Inside the “PCM Unit” housing 11, at least one layer of PMC assembly “cartridges” 13 are mounted with proper spacing to allow for air flow around the cartridges 13 for efficient transfer of heat from hot cartridges to the passing air flow. The “PCM Unit” housing 11 is provided with an inlet 14, through which the passing air flow enters the “PCM Unit” housing 11 and gets heated as it passes hot cartridges 13 and exits the outflow opening 15 to enter the electric powered vehicle cabin. It is appreciated that the “PCM Unit” housing is configured to act as an efficient heat exchanger using well known heat exchanger design methods commonly used in the art. In the schematic of FIG. 2, the arrow 16 shows the direction of air inflow into the “PCM Unit” housing and the arrow 17 shows the direction of air outflow from the “PCM Unit” housing. The air flow can be from an associated fan or similar device (not shown) or from convective air currents or from forced air flow due to movement of the electric vehicle (for at leas that portion of the heating while the vehicle is being operated. That is, the air flow can be generated using a fan powered by the line power when charging overnight and can be by forced air flow when the vehicle is moving (of course the more efficient method is to recirculate the cabin air with a fan, when the electric vehicle is both being charged and during use).

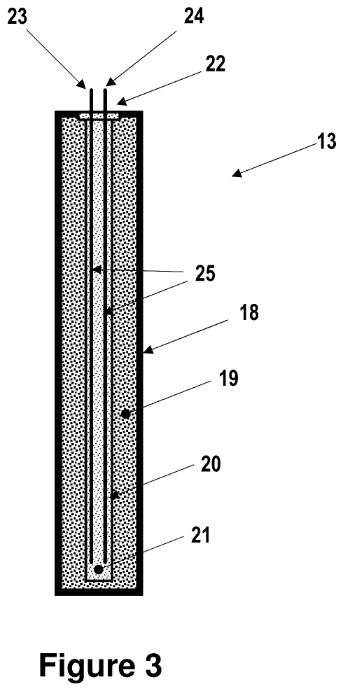

The cross-sectional view of a typical electrically heated PMC assembly cartridge 13 of the “Phase-Change-Material (PCM) Heat Energy Storage Unit” of FIG. 2 is shown in FIG. 3. The PMC assembly cartridges 13 are provided with a housing 18, within which is filled with the desired phase-change material (PCM) 19. An electrical heating element with the housing 20 is positioned in the center of the PCM, within which the electrical heating elements 25 are positioned, surrounded with a high temperature and electrically non-conductive material 21 (usually a compacted powder such as aluminum nitride or the like) to eliminate electrical shorts). The terminals 23 and 24 of the electrical heating elements are then passed through an electrical insulation element 22 for connection to the electrical input connections of the “Phase-Change-Material (PCM) Heat Energy Storage Unit” 10.

As can be seen in the block diagram of FIG. 1, the “PCM Heater” and the “Integrated Battery Heater and Charger” components are powered by an external power source, usually commercial line power or in certain cases generator or stored electrical energy sources. These two components of the system are in general installed in a parking area used by the electric powered vehicle. For applications such as school or city buses or utility or construction equipment or the like, which are parked overnight and must be ready for operation in the morning next day, the “PCM Heater” and the “Integrated Battery Heater and Charger” components can be at each electric powered vehicle parking spot so that the vehicle batteries could be brought to its optimal charging temperature and fully charged and then brought to its optimal operating temperature (if different) by the “Integrated Battery Heater and Charger”, and the “Phase-Change-Material (PCM) Heat Energy Storage Unit” would be brought to its prescribed initial temperature by the time that the electric powered vehicle needs to leave the parking area to provide its service.

It is appreciated, that as described in the aforementioned U.S. Pat. Nos. 10,063,076; 10,855,085; 11,211,809; 11,211,810; 11,594,908; 12,074,301, as well as U.S. Patent Application Publication Nos. 2020/0176835; 2021/0304972; 2021/0307113; 2022/0113750; 2023/0344029; 2024/0136616; 2023/0359231 and U.S. patent application Ser. No. 18/244,275, the entire contents of each of which are incorporated herein by reference, the “Integrated Battery Heater and Charger” units can be configured to measure the temperature of the batteries of the “Electrical Energy Storage Unit” of the electric powered vehicle and if their temperature is below the optimal charging temperature of the batteries, then it would apply the heating high frequency current to the batteries to directly heat their electrolytes. The “Integrated Battery Heater and Charger” units are readily programmed by the user by entering the time at which the “Electrical Energy Storage Unit” batteries must be fully charged and at optimal operating temperature. The “Integrated Battery Heater and Charger” control unit would then measure the environmental and battery temperatures and the state of charge of the batteries and plans an optimal rate of heating and charging to have the “Electrical Energy Storage Unit” ready at the indicate time at which the electric powered vehicle is planned to leave the parking area and begin its service. The “Phase-Change-Material (PCM) Heat Energy Storage Unit” is also heated to the prescribed initial operating temperature and the vehicle cabin heated to a predetermined temperature by such time, as described below.

In general, the “PCM Heater” component shown in the block diagram of FIG. 1 would provide the electrical connection to the electric powered vehicle for use in the “Phase-Change-Material (PCM) Heat Energy Storage Unit”. The user would then “plug-in” the provided connector of the “PCM Heater” cable into provided receptor on the electric powered vehicle. The “Control Unit” of the electric powered vehicle, FIG. 1, is then programmed by the user by entering the time at which the “Phase-Change-Material (PCM) Heat Energy Storage Unit” must be at its initial operating temperature. The “Control Unit” would then monitor the temperature of the “Phase-Change-Material (PCM) Heat Energy Storage Unit” and set the time at “PCM Heater” power must be switch on so that the “Phase-Change-Material (PCM) Heat Energy Storage Unit” would reach its prescribed initial operating temperature by the time that the electric powered vehicle is planned to leave the parking area and begin its service. The control unit can alternatively be provided separate from the electric vehicle.

Then as the electric powered vehicle leaves the parking and starts its service, then the “Control Unit” would continuously monitor the vehicle cabin temperature commonly used in most vehicles, and when the cabin interior temperature drops below the level that has been set to indicate the minimum comfortable temperature level for the vehicle occupants, then the “Control Unit” would circulate the interior air of the cabin through the “Phase-Change-Material (PCM) Heat Energy Storage Unit” heat exchanger and bring the interior cabin temperature to its prescribed comfortable level. It is appreciated by those skilled in the art that the methods and devices for circulating air in various vehicle cabins for heating or cooling, and with full or partial outside and inside air mixtures with proper blowers, valves, and air ducts are known and are not shown in the block diagram of FIG. 1.

It is appreciated that in general, such as for applications for school or city (municipality) transit buses, the electric powered vehicle cabin can be brought to a comfortable temperature for the passengers at the start of the vehicle service, i.e., before the electric powered vehicle leaves its aforementioned parking space. It is appreciated that by using power from the external power source, the stored electrical of the “Electrical Energy Storage Unit” and the stored heat energy of the “Phase-Change-Material (PCM) Heat Energy Storage Unit” are saved for use while the electric powered vehicle is providing its service, thereby increasing the time and distance that the vehicle can comfortably transport its occupants for the case of the school or city transit buses.

In general, two different methods may be used to bring the cabin temperature to a comfortable level for the occupants while the electric powered vehicle is parked, and the external power source (line power) is available for battery charging and “Phase-Change-Material (PCM) Heat Energy Storage Unit” heating as was previously described. In both methods, the cabin temperature heating is generally initiated by the “Control Unit” at the required time depending on the measured environmental and cabin temperatures such that the internal cabin temperature is at a comfortable temperature for its occupants once the electric powered vehicle leaves the parking and begins its service.

In the first method, a separate “Cabin Heater”, shown with dashed lines in the block diagram of FIG. 1, can be provided at the parking station of the electric powered vehicle and once activated by the user, or preferably by the “Control Unit” of the electric powered vehicle, would blow heated air into the air circulation ducts of the vehicle that is used to keep the cabin temperature at a comfortable temperature for the occupants while the electric powered vehicle is in service. It is appreciated by those skilled in the art that alternatively, the “Cabin Heater” (such as a conventional resistance heater) may be installed in the electric powered vehicle and only use a connection to the external power source (line power) to power the unit heater and air circulating members.

It is appreciated that the provision of an external “Cabin Heater” would save space and weight in the electric powered vehicle. The advantage of providing a “Cabin Heater” unit inside the electric powered vehicle is that it could also be used to be powered by the “Electrical Energy Storage Unit” while the electric powered vehicle is being operated in service if it becomes necessary to keep the cabin temperature at a comfortable temperature for its occupants.

In the second method, a separate “Cabin Heater” is not provided either inside the electric powered vehicle or at the parting station as shown in the block diagram of FIG. 1. In this method, stored heat from the “Phase-Change-Material (PCM) Heat Energy Storage Unit”, while being heated by the external power source, is used to heat the cabin air as it is circulated through it as it was previously described. The main advantage of this method is that it eliminated the need for a separate “Cabin Heater” and air ducts and blowers and related actuated air valves. However, the disadvantage of this method is that a “Cabin Heater” may also be needed in the electric powered vehicles in those cases in which at some point it might become necessary to use power from the “Electrical Energy Storage Unit” to keep the cabin temperature comfortable for its occupants.

The external power source (line power) powered system shown in the block diagram of FIG. 1 would then operate as follows.

The electric powered vehicle, such as a school or city transit electric powered or hybrid powered bus, is parked in the system equipped parking spot. In this parking spot, the electric powered vehicle has access to the provided line powered “Integrated Battery Heater and Charger” and “PMC Heater” (if not integrated into the “Phase-Change-Material (PCM) Heat Energy Storage Unit”—and if it, then only line power access is to be provided at the parking station) units. It is also appreciated that the “Cabin Heater” is preferably positioned inside the electric powered vehicle and a line power connection is only required at the parking station to provide it with power as it was previously described. However, if the “Cabin Heater” is provided at the parking station, then proper flexible connecting ducts and its connection to the vehicle inlet and its circulation blowers and routing valves, etc., as are commonly known in the art, have to be provided in the vehicle and operated by the vehicle “Control Unit”.

The next step for the user is to set the time at which the “Electrical energy Storage Unit” must be fully charged and at its optimal operating temperature, the “Phase-Change-Material (PCM) Heat Energy Storage Unit” must be heated to its prescribed temperature, and that the cabin temperature must be at the prescribed occupant comfortable temperature. The microprocessor that provided in the “Control Unit” would then use its programmed instructions and measure the current and expected environmental temperature at the set time and also measured the current temperature of the “Phase-Change-Material (PCM) Heat Energy Storage Unit” and the cabin temperature and the state of charge of the “Electrical Energy Storage Unit” batteries, and plan the process of charging the “Electrical Energy Storage Unit” batteries as it was previously described and bringing the temperature of the “Phase-Change-Material (PCM) Heat Energy Storage Unit” and the cabin temperature to their prescribed level by the time that the electric powered vehicle has to leave the parking station and begin its service.

It is appreciated that when the environmental temperature is very low and depending on the type of batteries used in the “Electrical Energy Storage Units”, the battery temperature may begin to drop below its optimal operational range while the electric powered vehicle is in service. In which case, two basic methods may be used to maintain the “Electrical Energy Storage Unit” batteries within their optimal operating temperature range.

In the first method, a high-frequency self-heating circuit may be used as described in U.S. Pat. Nos. 10,063,076; 10,855,085; 11,211,809; 11,211,810; 11,594,908, each of which are incorporated herein by reference. The method uses battery power to bring its temperature within its optimal operating range.

In the second method, heat is transferred from the “Phase-Change-Material (PCM) Heat Energy Storage Unit” to the “Electrical Energy Storage Unit” compartment, usually via the cabin circulating air ducts. One advantage of this method is that it does not draw electrical energy from the “Electrical Energy Storage Unit” batteries, thereby does not reduce the operational time and range of the electric powered vehicle.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated but should be constructed to cover all modifications that may fall within the scope of the appended claims.

What is claimed is:

1. A system for thermal management of electric vehicles, the system comprising:
a heat energy storage system having a phase change material; and
a controller comprising hardware, the controller being configured to:
monitor a cabin temperature of a cabin of the electric vehicle; and
based on the cabin temperature, control power to the heat energy storage system to store heat energy therein; and
control an airflow at least indirectly across the phase change material to convert the stored heat energy to heating the cabin.

2. The system of claim 1, wherein the control of the power to the heat energy storage system occurs when the electric vehicle is not in use.

3. The system of claim 1, wherein the control of the air flow comprises controlling one or more of a fan and a duct provided within the vehicle.

4. The system of claim 1, wherein the controlling of the airflow comprises controlling a fan to provide the airflow.

5. The system of claim 1, wherein the controller is further configured to:
receive an input of a time when the cabin temperature of the cabin is to be heated to a predetermined temperature; and
the control of the power and the control of the airflow is based on the input.

6. The system of claim 5, wherein the controller is further configured to receive an input of the predetermined temperature.

7. The system of claim 1, wherein the controller is further configured to:
monitor a battery temperature of a battery in the electric vehicle;
control a high-frequency AC input signal to the battery to heat the battery to a predetermined temperature.

8. The system of claim 7, wherein the controller is further configured to:
receive an input of a time when the battery temperature of the battery is to be heated to a predetermined temperature; and
the control of the high-frequency AC input signal to the battery is based on the input.

9. The system of claim 8, wherein the controller is further configured to receive an input of the predetermined temperature.

10. The system of claim 1, wherein the heat energy storage system comprises:
a housing for containing the phase change material;
thermal insulation providing on the housing; and
an inlet and an outlet providing a flow path for the airflow.

11. The system of claim 10, wherein the heat energy storage further comprises one or more cartridges disposed within the housing, the one or more cartridges each comprising:
a cartridge housing;
the phase change material disposed in the cartridge housing;
an electric heating element positioned adjacent to the phase change material; and
electric terminal electrically connected to the electric heating element and connected to a power source.

12. The system of claim 11, wherein the one or more cartridges further comprises a high temperature electrically non-conductive material surrounding the electric heating element.

13. The system of claim 12, wherein the high temperature electrically non-conductive material is aluminum nitride.

14. A method for thermal management of electric vehicles, the method comprising:
monitoring a cabin temperature of a cabin of the electric vehicle; and
based on the cabin temperature, controlling power to a heat energy storage system having a phase change material to store heat energy therein; and
controlling an airflow at least indirectly across the phase change material to convert the stored heat energy to heating the cabin.
